(19) United States
(12) Patent Application Publication
(10) Pub. No.: US 2002/0076215 A1
(43) Pub. Date: Jun. 20, 2002

(54) Constant temperature device

(76) Inventor: Cheng-Shang Tsao, Taipei (TW)

Correspondence Address: BROWDY AND NEIMARK, P.L.L.C., 624 NINTH STREET, NW, SUITE 300, WASHINGTON, DC, 20001-5303, US

(21) Appl. No.: 09/950,418

(22) Filed: Sep. 11, 2001

(30) Foreign Application Priority Data
Dec. 18, 2000 (TW) 89221939

(51) Int. Cl. H05B 3/26; H05B 3/46

(52) U.S. Cl. 392/439; 219/543

(57) ABSTRACT

The present invention relates to a constant temperature device that comprises a base, a heating thin layer which is coated on the base, and two electric nodes that locate at the two ends of the heating thin layer respectively. The base is made of insulated materials such as glass and ceramic. The heating thin layer is made by a mix of various materials and is coated on the base by the Physical Vapor Deposition (PVD) processing, Chemical Vapor Deposition (CVD) processing or other coating techniques such that the mix of material can be evenly distributed on one side of the base. Once the power is through via the two nodes, the heating thin layer will act as a thermally sensitive resistor (thermistor) to automatically keep the temperature at a pre-set level so as to save energy and ensure the safety of use thereof.

### FIELD OF THE INVENTION

The present invention relates generally to a temperature controller of heating equipment, and more particularly to a constant temperature device that can generate heat with constant temperature.

### BACKGROUND OF THE INVENTION

Most heat generating equipment such as toasters and ovens have nickel coils or quartz pipes installed on their sides or bottoms. Once the power is through, heat will be generated to warm food up. However, such equipment has following flaws:

First, because the design is to put heating objects such as nickel coils and quartz pipes into a shape of circular pipes, it is not suitable to directly put any food on top of it for heating. As a result, it is necessary to direct air for heating to warm up food. During so results the loss of some heat from the air and reduces the efficiency in heating and problems

Secondly, the impedance and quartz pipes take up too much space and require a much bigger space in the baking equipment. Such a feature is not suitable for modern living condition.

Thirdly, in order to prevent the temperature from rising infinitely, it is necessary to add a temperature controller in the baking equipment so that the equipment can keep the temperature at a pre-set level. Doing so will also rule out the possibility for electricity waste (from infinite rise of temperature), burns or fires. Yet, the addition of such a temperature controller will create additional waste of electricity.

### SUMMARY OF THE INVENTION

Therefore, the primary objective of the present invention is to provide a constant temperature device to be installed in baking or heating equipment to increase the heating efficiency.

Another objective of the present invention is to provide a constant temperature device to be installed in baking or heating equipment to automatically keep the temperature at a constant level to save energy.

Another objective of the present invention is to provide a constant temperature device to be installed in baking or heating equipment to increase the safety of their use.

In order to reach the goals described above, the present invention provides a constant temperature device that comprises a base, a heating thin layer which is coated on the base, and two electric nodes that locate at the two ends of the heating thin layer respectively. The base is made of insulated materials such as glass and ceramic. The heating thin layer is made by a mix of various materials and is coated on the base by Physical Vapor Deposition (PVD) processing, Chemical Vapor Deposition (CVD) processing or other coating techniques such that the mix of material can be evenly distributed on one side of the base. Once the power is through, the heating thin layer will act as a thermally sensitive resistor (thermistor) to automatically keep the temperature at a pre-set level. Such a feature can save energy and ensure the safety of use thereof.

### BRIEF DESCRIPTION OF THE DRAWINGS

FIG. 1 shows a perspective view of a first preferred embodiment of the present invention.

FIG. 2 shows a schematic view of the preferred embodiment of the present invention in use.

FIG. 3 shows a perspective view of a second preferred embodiment of the present invention

FIG. 4 shows a schematic view of the second preferred embodiment of the present invention it use

### DETAILED DESCRIPTION OF THE INVENTION

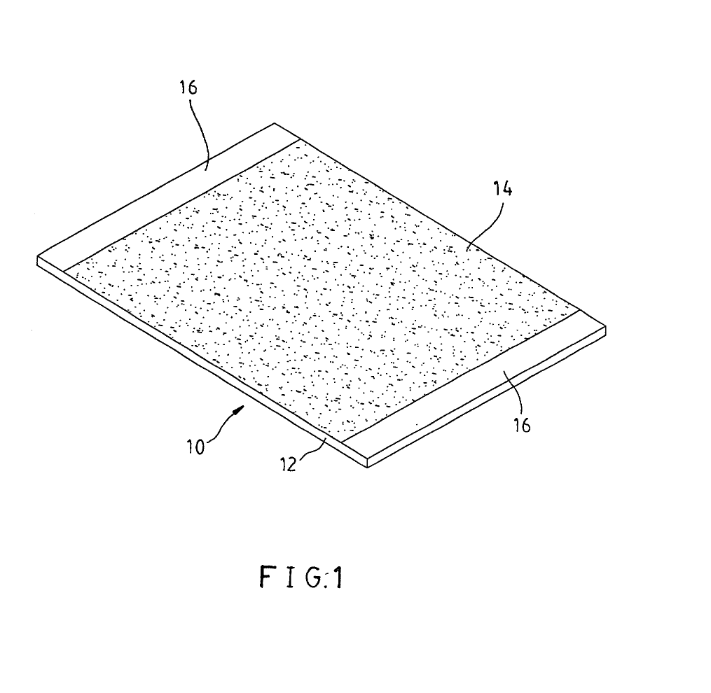

As shown in FIG. 1, a constant temperature device 10 of the first preferred embodiment of the present invention comprises an insulated base 12, a heating thin layer 14 and two electric nodes 16.

The insulated base 12 is made of general glass, microcrystal glass, ceramic, mica or other insulated materials. The heating thin layer 14 is made of the mix of various materials including nickel, chromium (Cr), iron and thermal-sensitive ceramic powder which contains barium titanate (BaTiO₃) with a positive temperature coefficient (PTC). It uses physical vapor deposition (PVD processing, chemical vapor deposition (CVD) processing or other coating techniques to distribute the mix of materials evenly on one side of the base 12. The two electric nodes 16 are located on two ends of the heating thin layer 14.

Due to such a design, once the power is through, the heating thin layer 14 will exert the influence of negative temperature coefficient to make the current decrease along with the increase of temperature. Such a reaction is called thermally sensitive resistor effect. It helps the equipment to automatically control the temperature at a pre-set level. Then, if the device of this invention is installed in general heating equipment, there will not be any need for install additional temperature controller so as to avoid electricity waste, burns and fires caused by the infinite rise of temperature. Moreover, it can save energy and ensure the safety of use.

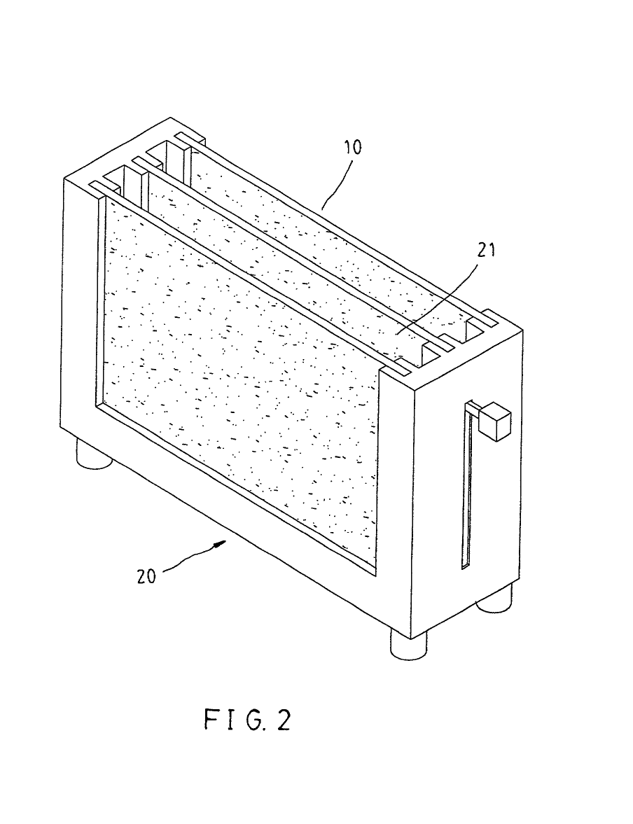

Please refer to FIG. 2. The constant temperature devices of the present invention are installed in to the toaster 20 and are arranged in a vertical manner. Then a heating space 21 will be formed between each base material 12 for the insertion of bread. When the power is through, the heating thin layer 14 will generate a big amount of heat and transmit the heat to the flat boards to reach the goal of high and even temperature. Moreover, the device will be able to keep the temperature at a pre-set level to evenly warm up bread. The constant temperature devices can be installed at the bottom and the side of an oven (not shown in the illustration) to form a heat generator of the oven.

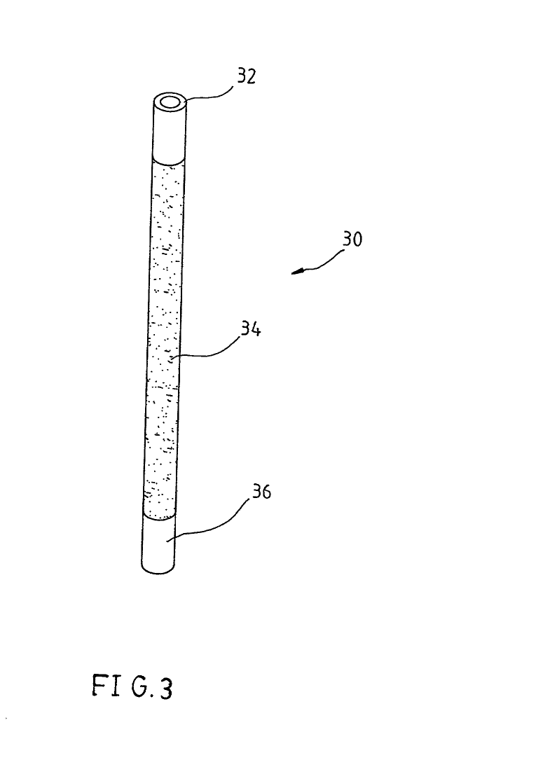

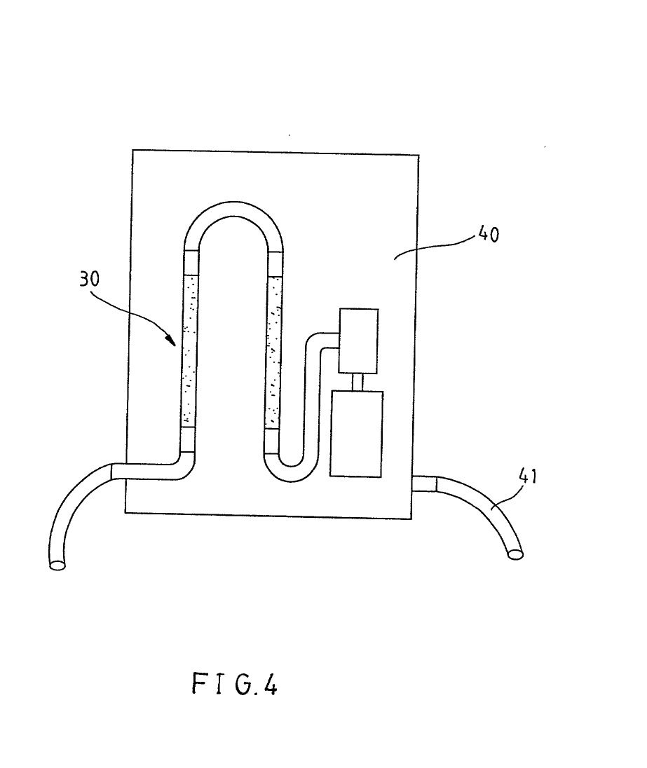

As shown in FIGS. 3-4, the constant temperature device 30 of the second preferred embodiment of the present invention comprises an insulated base 32, a heating thin layer 34 and two electric nodes 36. The base 32 is made of general glass, microcrystal glass, ceramic or other insulated materials in a form of a hollow stick. The heating thin layer 34 is arranged around the outer circumference of the stick. The two electric nodes 36 are located at two ends of the stick. Connect several base material 32 to a pre-set water storage barrel 40 through soft pipes 41 to be the heating source for water.

Therefore, the present invention has the following advantages.

First, the constant temperature device of present invention uses an insulated base as its heating surface that has the effect of even temperature and high efficiency. It does not use the traditional designs of heating pipes such as nickel coils or quartz pipes. As a result, it can minimize the loss of heat between transmissions.

Secondly, the size of the constant temperature device of present invention is really small and can greatly reduce the space taken up by heating structure used in the past and provide customers with a better choice for their limited space.

Thirdly, the constant temperature device of the present invention can keep the temperature at a pre-set level to save energy and ensure the safety of use. Moreover, it is not necessary to install any additional device for temperature control. Such a design emphasizes the concept of environmental protection.

To sum up, the constant temperature device of the present invention has many advantages compared with the traditional heating device used in baking equipment. The results of experiment have demonstrated that this invention can reach the goals that it was designed for. It is both practical and advanced to meet the requirement of patent application. In order to protect the hard work from the inventor, this application of patent is filed for processing.

What is claimed is:

1. A constant temperature device comprising:
a base made of glass, ceramic or other insulated materials;
a heating thin layer made by a mix of various materials including nickel, chromium, iron, and thermo-sensitive ceramic powder with a positive temperature coefficient, said thin layer is coated on the base by means of physical vapor deposition processing, chemical vapor deposition processing or other coating techniques;
two electric nodes located at two ends of the heating thin layer;
when the power is provided via said two nodes, the heating thin layer will act as a thermally sensitive resistor to automatically keep the temperature at a pre-set level so as to save energy and ensure the safety of use thereof.

2. The device as defined in claim 1, wherein said base is a flat board, and the heating thin layer is coated on one side of the flat board.

3. The device as defined in claim 1, wherein said base is a hollow stick, and the heating thin layer is coated on the outer circumference of the hollow stick.
